(19) United States
(12) Patent Application Publication
(10) Pub. No.: US 2003/0019806 A1
(43) Pub. Date: Jan. 30, 2003

(54) Constant level skimmer

(76) Inventor: Mark Anthony Crudele, Parkersburg, WV (US)

Correspondence Address: MARK A. CRUDELE, 56 CAPTAIN AMES DRIVE, PARKERSBURG, WV, 26101, US

(21) Appl. No.: 09/918,426

(22) Filed: Jul. 30, 2001

(51) Int. Cl. C02F 1/40

(52) U.S. Cl. 210/242.1

(57) ABSTRACT

The Constant Level Skimmer is a device used to remove solids from the surface of a water treatment facility. The device floats on the surface, skimming solids into the facility skimmer piping.

The Constant Level Skimmer consists of two plastic floats, one stainless steel plate, two lock collars, one four inch section of two inch threaded PVC pipe, and one ten inch neoprene bellows.

The floats are attached near the ends of the stainless steel plate with stainless steel screws. The two inch PVC pipe is attached to the center of the steel plate with two locking collars. The bellows attach to the PVC pipe.

The device is put into use by sliding the bottom end of the bellows into the existing skimmer piping of the sewer treatment facility. The floats and bellows of the device maintain a level of the skimmer intake which is optimal for removing solids from the surface of the water treatment facility.

### BACKGROUND

Removing solids from the surface of the water treatment facility has always been a problem because the water level is often too high or too low for the skimmer. My invention maintains the optimal level for the removal of floating solids.

### DRAWING

FIG. 1 shows a side view of the Constant Level Skimmer.

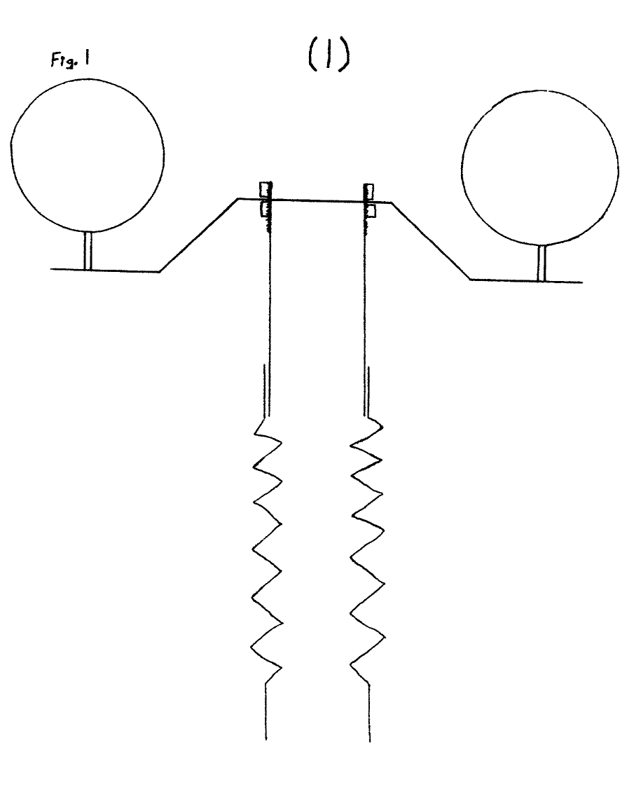

FIG. 2 shows a bottom view of the Constant Level Skimmer.

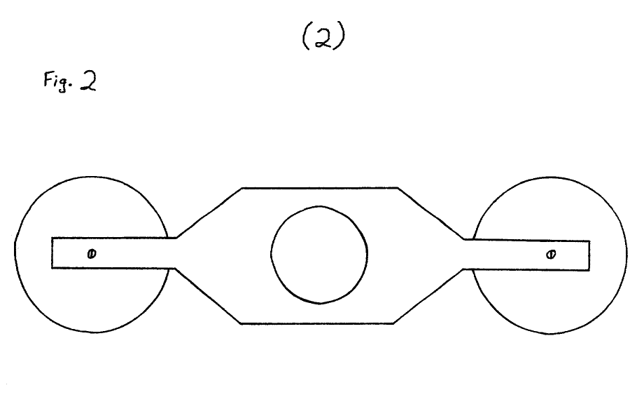

1. What I claim as my invention is a device with bellows and floats which maintains the optimal level for the removal of solids from the surface of a water treatment facility:
